(19) United States
(12) Patent Application Publication
(10) Pub. No.: US 2010/0211442 A1
(43) Pub. Date: Aug. 19, 2010

(54) Real-Time Digital Content Display System

(76) Inventors: Anita Venkataraman, Calabasas, CA (US); Arpit Malaviya, Calabasas, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/707,538

(22) Filed: Feb. 17, 2010

Related U.S. Application Data
(60) Provisional application No. 61/207,977, filed on Feb. 17, 2009.

(51) Int. Cl. G06Q 30/00; G06Q 50/00; G06F 17/30

(52) U.S. Cl. 705/14.5; 707/736; 707/607; 707/748; 705/14.67

(57) ABSTRACT

There is disclosed a method for delivering real-time digital content on a network. A server device receives real-time flight information, an airport information, an airline information, and content information and generates a group playlist based on the real-time flight information, the airport information, the airline information, and the content information. The server device then transmits the group playlist to a client device. There is also disclosed a system for delivering real-time content on a network comprising a server device and a client device.

### RELATED APPLICATION INFORMATION

This patent claims priority from the following provisional patent applications: U.S. Application No. 61/207,977 entitled, “Statistical Analysis Driven Real-Time Digital Content Display System” filed Feb. 17, 2009.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to displaying real-time digital content on a system.

2. Description of the Related Art

In recent years, the number of air travelers has significantly increased. This increase in air travelers has opened the doors for advertisers and content providers to target these air travelers while en route to their final destination. Many passengers on average wait from thirty to sixty minutes at their departure gate before being seated on their plane. Moreover, increased security measures at airports have increased the average time passengers wait at their departure gate because passengers are now arriving much earlier to the airport so as to allow for more than enough time to pass through the security checkpoints. The time that travelers spend waiting at the departure gate for their flight, provides advertisers and content providers a minimum of a thirty to sixty minute window for targeting a captive audience at a departure gate.

Digital content display systems have evolved in recent years to target advertisements and content to people while in public places, such as airports. Many of these digital content display systems usually are preloaded with advertisements and content programming that are continuously repeated after cycling through the content once. Some of the digital content display systems currently in airports allow passengers to view broadcast TV, such as CBS, CNN Headline News, and other television network programming. However, passengers at Gate 1 headed to New York likely may not wish to see the same content as passengers at Gate 4 headed to Alaska. In addition, business passengers traveling to San Jose on a Monday morning likely would not be interested in seeing the same content as vacationers traveling to San Jose on a Saturday morning. Therefore, advertisers and content providers would significantly benefit if they could customize the ads and content shown based on information of the group of passengers at a certain gate and their final destination information.

### DESCRIPTION OF THE DRAWINGS

FIG. 1 is a block diagram of a system in which real-time digital content may be displayed.

FIG. 2 is a block diagram of a real-time digital content display system.

FIG. 3 is a flow diagram of a process for displaying real-time digital content on a system.

FIG. 4 is a flow diagram of a process for creating a group playlist used for displaying the real-time digital content on a system.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

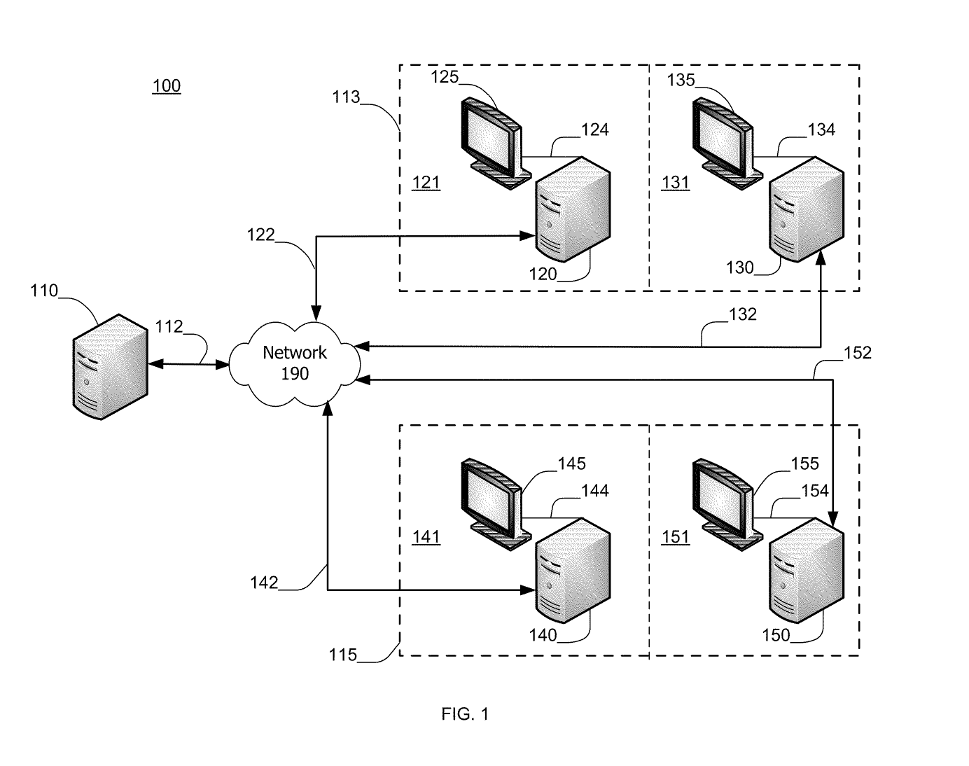

FIG. 1 shows a block diagram of a system 100 in which real-time digital content may be displayed. The system 100 may include a server device 110, and client devices 120, 130, 140 and 150. The server device 110 may be connected over a network 190 to client devices 120, 130, 140 and 150 by respective links 112, 122, 132, 142 and 152. The system may comprise only one client device, which may be client device 120, or the system may comprise numerous client devices as shown in FIG. 1. Similarly, the system may comprise one server device, which may be server device 110 shown in FIG. 1, or the system may comprise multiple server devices.

The client devices 120, 130, 140 and 150 may reside in different physical locations. For example, client devices 120 and 130 may reside in one geographical location 113, such as the Santa Barbara Airport (SBA) located in Santa Barbara, Calif. Within SBA, client devices 120 and 130 may reside in different parts within geographical location 113. For example, client device 120 may reside at one part 121 which may be Terminal 1, Gate 1 and client device 130 may reside at a different part 131 which may be Terminal 1, Gate 10. Similarly, additional client devices may exist in all gates of every terminal at the Santa Barbara Airport, or in select gates and terminals at the Santa Barbara Airport.

Similarly, client devices 140 and 150 may reside in another geographical location 115, separate from geographical location 113. For example, client devices 140 and 150 may reside at the Missoula International Airport (MSO) located in Missoula, Mont. Within MSO, client device 140 may reside at one part 141 which is different than another part 151 that client device 150 resides at. For example, client device 140 may reside at Terminal 1, Gate 2 of MSO, while client device 150 may reside at Terminal 1, Gate 4 of MSO.

The client devices 120, 130, 140 and 150 may each be coupled to one or more display units, such as display units 125, 135, 145 and 155 respectively. Alternatively, the display unit may be included with the client device, such as if the client device were a laptop computer. The display units 125, 135, 145 and 155 may be LCD screens, plasma screens, CRT monitors, projectors, and the like. The display units 125, 135, 145 and 155 may be coupled to client devices 120, 130, 140 and 150 by respective links 124, 134, 144 and 154. Links 124, 134, 144 and 154 may be a Video Graphics Array (VGA) connection, a Digital Visual Interface (DVI) connection, a High-Definition Multimedia Interface (HDMI) connection, a Component video connection, or any cable capable of providing high visual quality on a digital display unit.

The network 190 may be a local area network, a wide area network, a wired network, a wireless network, or a combination of these networks and other networks. The network 190 may be a packet-switched network and it may comprise a common or private bi-directional data network, and may be, for example the Internet or utilise the IP protocol. The network 190 may be a common carrier network which provides circuit switching and/or IP telephony between public users. Links 112, 122, 132, 142 and 152 which connect server device 110 to client devices 120, 130, 140 and 150 respectively may commonly be wired or fiber optic links but may also be wholly or partially wireless links.

The server device 110 and client devices 120, 130, 140 and 150 may be computing devices. A computing device as used herein refers to any device with a processor, and a memory that may execute instructions including, but not limited to, personal computers, servers, portable computers, cellular/mobile telephones, personal digital assistants (PDAs), computer workstations, computing tablets, e-mail appliances, digital signage systems, smart display terminals, and the like. These computing devices may run an operating system, including, for example, variations of UNIX, Microsoft Windows, Symbian, and Apple Mac operating systems.

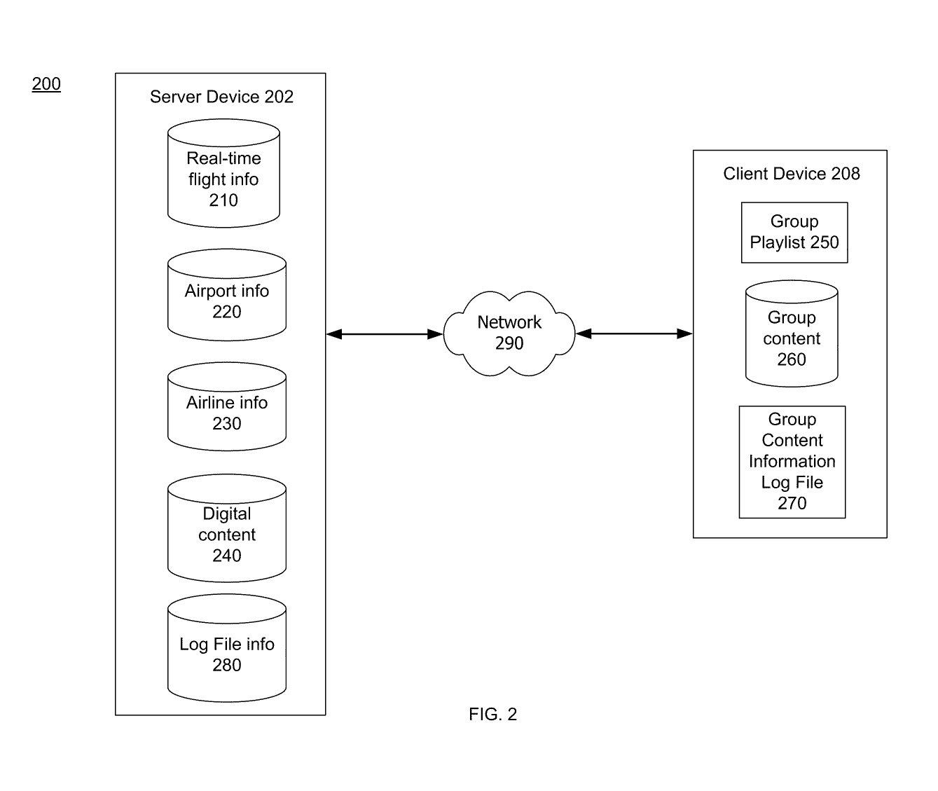

Referring to FIG. 2, a block diagram of a real-time digital content display system 200 is shown. FIG. 2 comprises server device 202, which may be server device 110 of FIG. 1, client device 208, which may be any of client devices 120, 130, 140 and 150 of FIG. 1, and network 290, which is similar to network 190 of FIG. 1. While a real-time digital content display system may include many server devices and many client devices, the following description is simplified to one server device 202 and one client device 208.

The server device 202 may include memory (not shown) which may store database information such as databases 210, 220, 230, 240 and 280. Specifically, server device 202 may comprise a real-time flight information database 210, an airport information database 220, an airline information database 230, a digital content 240 database, and a log file information database 280. These databases may be created as separate databases as shown in FIG. 2, or these databases may exist in one database.

The real-time flight information database 210 may comprise real-time flight information. The real-time flight information may be defined as information pertaining to a flight that is updated on at least a per minute basis, thereby accurately informing a passenger of information pertaining to his flight within a minute of precision. The real-time flight information may include information such as the time of the flight, the destination for the flight, the boarding time of the flight, and the gate at which the fight is departing from. In addition, the real-time flight information may comprise information such as whether the flight has been canceled, whether a gate change has occurred, and whether there have been any delays for the flight. For example, suppose there is a flight leaving at 8:00 am from Santa Barbara, Calif. to San Jose, Calif. from Terminal 1, Gate 1 at the Santa Barbara Airport. Passengers may begin waiting to board the flight by 7:30 am. From 7:30 am or so, passengers may begin viewing ad and content information catered for their flight. If at 7:40 am, it is discovered that the flight is delayed 30 minutes and is now departing from Terminal 1, Gate 4, then the already checked-in passengers will begin moving to Terminal 1, Gate 4 so as to be in the boarding area for their flight. When the flight has been delayed and the gate has been changed as in this example, passengers can expect to see the same ad and content information that was created for their flight, but now they can view it at Terminal 1, Gate 4, the new boarding gate for their flight. Therefore, the real-time information database 210 provides the flight information in real-time. This data is then used to ensure that the passengers view the ad and content that was prepared for them.

The airport information database 220 may comprise airport information. Airport information may be defined as information specific to a certain airport. For example, the types of passengers and the destinations passengers are traveling to may differ from one airport to another airport. For example, passengers from Santa Barbara Airport may comprise different characteristics than passengers from Los Angeles International Airport, and the destinations of the passengers from SBA may differ from the destinations of the passengers from LAX. Therefore, the airport information database 220 may comprise airport information which is information specific to a certain airport.

The airport information may include the top destinations of travelers from that airport and the general passenger profile information of travelers traveling to and from that airport. The top destinations of travelers from an airport may be useful information for advertisers and content providers. For example, many passengers traveling through Rogue Valley International-Medford Airport (MFR) likely will travel to another airport to reach a connecting flight before reaching their destination. This is because one of the top destinations of travelers traveling through MFR might be a destination that MFR does not have any direct flights to. For instance, many passengers from MFR may have a final destination of Washington D.C. However, MFR may not have any direct flights to Washington D.C. Therefore, passengers wishing to travel to Washington D.C. from MFR, likely will need to use a connecting flight at another airport to get to their final destination in Washington D.C. This final destination information is important for advertisers so that travelers traveling to Washington D.C. may view ad and content programming based on Washington D.C. as opposed to the ad and content programming of the city they are traveling to from MFR to reach their connecting flight.

The airport information may also comprise general passenger profile information. The general passenger profile information may include an age range of travelers traveling to and from that airport and it may also include information regarding the counties they reside in. For example, the Santa Barbara Airport may have historical information indicating that passengers who fly in and out of SBA primarily live in Santa Barbara County and primarily are college students attending nearby colleges in Santa Barbara. The general passenger profile information may be useful for advertisers and content providers because knowing that the passengers primarily live in Santa Barbara may help identify what local advertising and content programming to show or not show. For example, based on the counties where the passengers of SBA primarily live, advertisers may recognize that it may be beneficial to advertise the Santa Barbara Zoo since many of the passengers likely live fairly near it. Similarly, content providers may wish to provide short segment content programming discussing features of the Santa Barbara Zoo. By the same token, advertisers and content providers may recognize that it may not be beneficial to advertise attractions like Sea World, which is located in San Diego, Calif. since Sea World is roughly 215 miles away from Santa Barbara.

The airport information may also comprise information such as the average amount of time that passengers wait at a gate after passing through the security checkpoints. This information may be used to determine a minimum amount of time that there may be a captive group audience at the gate who would be interested in seeing targeted digital content. Therefore, the airport information database 220 provides general passenger profile information, average wait time at a departure gate and the top destinations of travelers from that airport.

The airline information database 230 may comprise airline information. Airline information may be defined as information specific to one of the airlines' flights. For example, American Airlines (“AA”) may have different airline information for a 10:00 am flight from Los Angeles, Calif. to San Francisco, Calif. as compared with a 10:00 am AA flight from Burbank, Calif. to Seattle, Wash. The airline information may include the destination of the flight, the load factor of the flight, the number of business versus leisure travelers, the number of travelers traveling in a group, the age range of passengers on the flight, the number of frequent flyers on the flight, and seasonal flight information. The seasonal flight information may include information such as students' summer holidays are between May to August. This seasonal flight information may be used to aid in determining the best ad and content programming for the passengers on the flight.

The digital content database 240 may comprise the advertising and content information. The content information may include the digital images and digital video files of the digital content that is to be displayed on a display unit, which may be display units 125, 135, 145, and 155 shown in FIG. 1. The content information may also include any other type of file that can comprise digital content. The content information may also include short segments of real-time data. For example, the short segments of real-time data may include local news, national news, international news, breaking news alerts, stock market highlights, weather news and sports information. The short segments of real-time data may be stored as URL links, where the client device goes to the web page identified by the URL link and then retrieves the real-time data regarding the latest sports news.

The digital content database 240 may also comprise information regarding the desired targeted group for a flight. For example, an advertiser who provides an ad for the Santa Barbara Zoo may state that they wish for the ad to be shown when more than 50% of the passengers are leisure travelers and not business travelers. Similarly, a content provider who provides content regarding a local professional office, such as a local law firm, may state that they wish for the ad to be shown when more than 75% of the passengers are business travelers. Therefore, advertisers and content providers may state for each ad or content what the desired group characteristics (i.e. 75% leisure travelers, etc.) for that ad or content are.

The server device 202 may also comprise a group playlist database (not shown). A group playlist may identify the ad and content programming that should be displayed on a client device 208 and that was selected for a particular flight. The group playlist may also identify the order the ad and content programming should be played in. The group playlist database may store a group playlist for every client device that exists. For example, in FIG. 1, four client devices are shown, namely client devices 120, 130, 140 and 150. In this example, server device 202, may store four corresponding group playlists in the group playlist database, one group playlist for each of the four client devices.

The client device 208 may comprise a group playlist 250, a group content database 260 and a group content information log file 270. The client device 208 may be any of the client devices shown in FIG. 1, such as client devices 120, 130, 140 and 150. The group playlist 250 may be a file, or other similar format, that identifies the ad and content programming that was selected for a particular flight based on the overall characteristics of the passenger profile. For example, if the passengers on a certain flight primarily comprise passengers traveling in a group of four where two of the passengers are under 13, then the group playlist created may comprise ads and content for leisure travelers and family related activities.

The group content database 260 may comprise the actual ad and content information to be played on the client device 208. For example, if the group playlist 250 identifies at least ten ads and content that is to be displayed, then the group content database 260 would store the files needed to show those ten ads and content.

The group content information log file 270 may be a file, or other similar format, that identifies what ad and content programming was displayed on the client device 208. The group content information log file may include information such as the number of viewers who watched the content, the date and time the content was displayed, and the frequency with which the content was displayed. The group content information log file may also include information such as the location and duration of the ad, and the aggregate playtime per day, week or month. The group content information log file would be useful to the advertising and content providers so that the providers know whether their content was displayed or not. In addition, logging the advertising and content information will ensure that advertising and content providers are not charged for content that was never displayed.

The server device 202 may also comprise a log file information database 280. The log file information database 280 may store the group content information log file 270 of client device 208. Similarly, the log file information database may store other group content information log files for other client devices networked on the system, for example client devices 120, 130, 140 and 150 of FIG. 1. The server device 302 may provide an interface for advertising and content providers to query the log file information database 280 to view the group content information log file to see the type of interest their ads and content had on the viewing public, to see whether the ads or content actually were displayed, to see where and at what time the ads or content were displayed, and to see the location information of where the ads or content were displayed.

The server device 202 and the client device 208 may include hardware and software for providing functionality and features described herein. The server device 202 and the client device 208 may therefore include analog circuits, digital circuits, software, firmware, and processors such as microprocessors, digital signal processor, field programmable gate arrays (FPGAs), application specific integrated circuits (ASICs), programmable logic devices (PLDs) and programmable logic arrays (PLAs). The depictions of the server device 202 and the client device 208 as functional elements in FIG. 2 does not imply a corresponding physical separation or demarcation. All or portions of the real-time flight information database 210, airport information database 220, airline information database 230 and digital content database 240 of the server device 202, and all or portions of the group playlist 250 and the group playlist database 260 may be implemented using a common integrated circuit chip and/or by software running on a common processor. The hardware and software and their functions may be distributed such that some functional elements may be implemented by one or more processors and other elements by other devices. The server device 202 and the client device 208 may also comprise peripheral devices such as audio speakers, cameras, motion detectors, and sensors.

Description of Processes

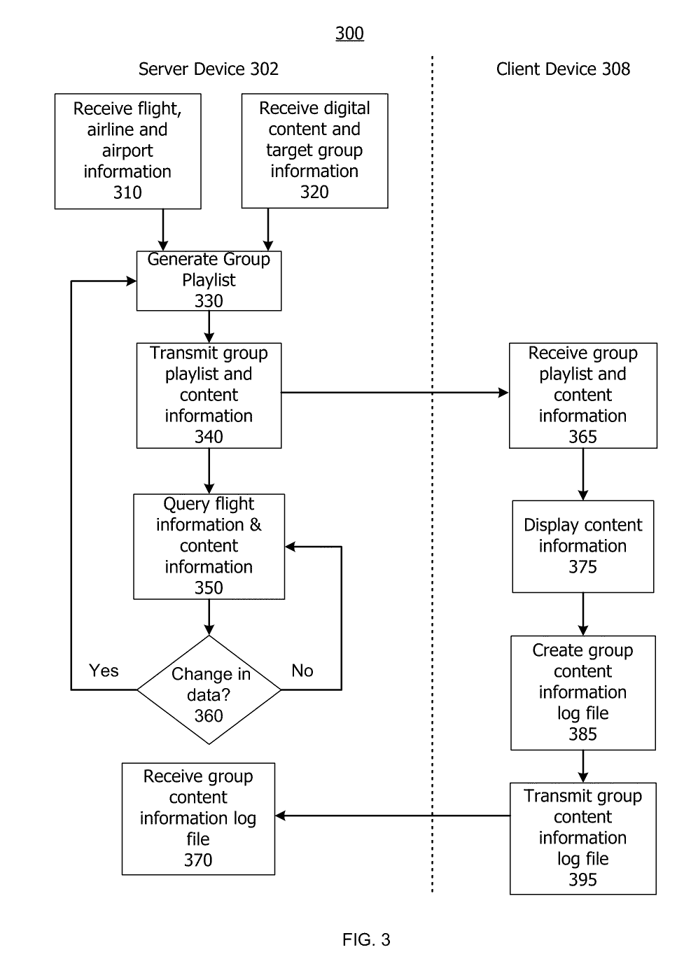

Referring now to FIG. 3, a process 300 for displaying real-time digital content on a system is shown. The process includes steps performed on a server device 302, which may be server device 202 of FIG. 2, and a client device 308, which may be client device 208 of FIG. 2.

Although the steps in the process 300 are described as separate, they may overlap in time. Furthermore, there may be many server devices and many client devices performing various steps of the process, and their performance may be varied in time and order. The following description is simplified to one server device 302, which may be server device 202 of FIG. 2, and one client device 308, which may be client device 208 of FIG. 2.

The process 300 for displaying real-time digital content begins on the server device 302. At 310, the server device 302 receives real-time flight information, airline information and airport information. The server device 302 receives the real-time flight information from real-time information database 210, the airline information from airline information database 220, and airport information from airport information 230. Alternatively, the server device 302 may receive the flight information, airline information, and airport information from an external server.

At 320, the server device 302 receives content information. The server device 302 may receive the content information by an advertising or content provider uploading its digital content to the server device 302. The server device may include an interface which allows an advertising or content provider to seamlessly upload the content to the server device 302. The advertising content and programming content may be in the form of images or video data, or any other form of digital data. Providing the advertising or content provider with the ability to upload new digital content at any time allows providers the opportunity to target customers better using real-time digital content.

The content information may also include desired targeted group information for a flight. That is, the advertising or content providers may provide information about the type of people the providers wish to target with their content. The desired targeted group information may include an age range, the number of males that are desired to be on the flight, the number of frequent flyers desired on the flight and the number of business travelers desired on the flight. In addition, the desired targeted group information may also identify the time of day, or the day of the week that the content should be displayed. Finally, the desired targeted group information may also identify a destination as a criteria for who to target the content to.

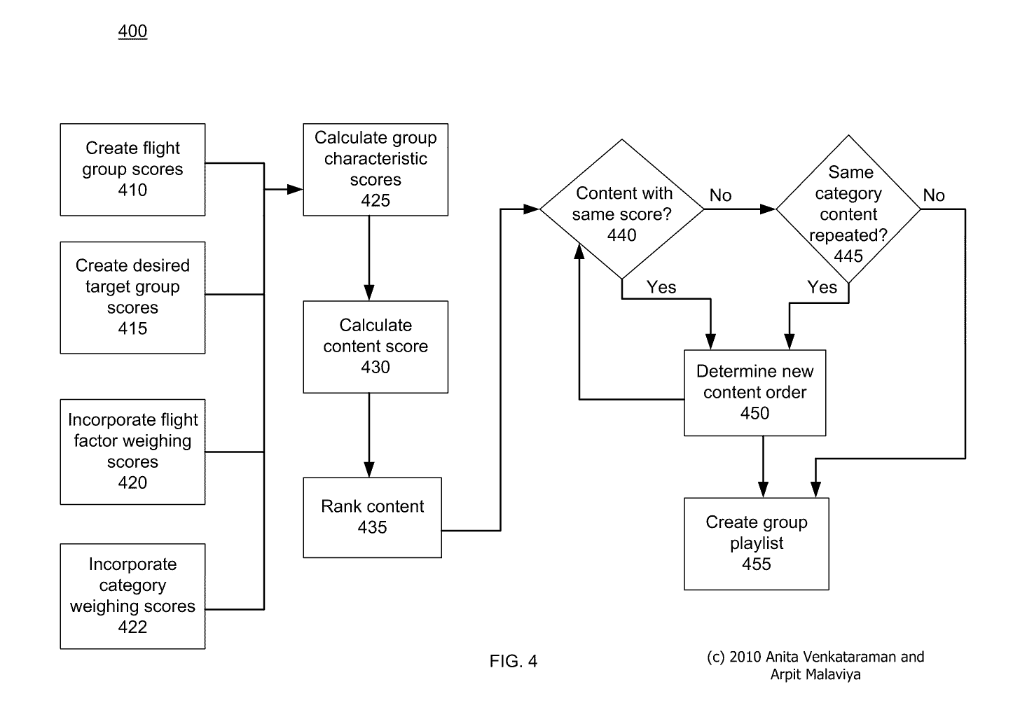

At 330, a group playlist is generated using the flight information, airline information, airport information and the content information. The group playlist that is generated may comprise a file indicating the order the digital content is to be displayed and the filenames of the digital content that is to be displayed on the client device. The group playlist is generated by determining which ads and content might be the most relevant for each passenger group. The ad and content selection may be based on all of the information received, for example the flight information, the airline information, the airport information and the content information. Alternatively, the group playlist may be generated using only a subset of all of the factors such as frequent flyer passenger ratio and gender ratio. Additionally, the group playlist may be generated based on the time of day of the flight, the day of the week of the flight, and other desired group target information. Generating the playlist is discussed more at length in FIG. 4 below.

Once the group playlist is generated at 330, the group playlist is transmitted at 340 to the client device 308. The transmitted data will include the group playlist and the content information, such as the digital content files needed for displaying the digital content on the client device. Before the group playlist is transmitted to the client device 308, the group playlist may be stored in the memory of the server device 302, for example in a group playlist database. The group playlist may also be stored in the client device 308.

At 350, the server device 302 may query the real-time flight information database and the content information database to determine whether the server device 302 has received any new information. The real-time information database needs to be queried often to determine whether there are any changes to the flight schedule. For example, the real-time information database will report if a flight is delayed, canceled or whether there are any terminal and/or gate changes for the flight. These changes will affect whether to continue playing the prepared group playlist on the associated client device or whether to begin playing the group playlist on a new client device situated elsewhere in the airport. Similarly, the content information database needs to be queried often to determine whether new content exists to be shown to the group passengers. For example, if a flight to Santa Barbara is delayed, then the client device may begin displaying ads having discount codes to purchase items from the concessionaires at the airport. That is, if a flight is delayed, then maybe the newspaper stand near the gate or the Starbuck Coffee located a few feet from the gate, may upload new content providing passengers of only that flight a coupon to receive discounted newspapers or discounted coffee. This feature allows an advertiser or content provider to display content in real-time, as soon as their new ad or content data is received by the server device 302. Since flight information can change instantly, the server device 302 may be configured to query the real-time flight information database very often, for example every minute or so. Similarly, the server device 302 may be configured to query the content information very often, for example every minute or so.

At 360, if the server device 302 does not detect any new real-time flight information or new content information, then the server device 302 returns to 350 to query the real-time flight information and content information. If however, the server device 302 detects new real-time flight information or new content information, then the server device generates a new group playlist. The new group playlist generated will use the new real-time flight information and/or content information that the server device 302 received. Once the group playlist is generated, the group playlist and any corresponding digital content files contained in the new group playlist are transmitted 340 to the client device at 308. The server device 302 may store the group playlist in a group playlist database (not shown).

At 365, the client device 308 receives the group playlist and the digital content files required to display the ad and content. Once the client device 308 receives the group playlist and the content information, the group playlist may be displayed at 375 on the display unit of the client device 308, for example on display units 125, 135, 145 and 155 of FIG. 1.

At 385, the client device 308 may create a group content information log file. The group content information log file may indicate the advertising and content information that was displayed on the client device 308, which may be the client devices 120, 130, 140 and 150. The group content information log file may include information such as the number of viewers who watched the content, the date and time the content was displayed, and the frequency with which the content was displayed. The group content information log file may also include information such as the location and duration of the ad, and the aggregate playtime per day, week or month.

The group content information log file would be useful to the advertising and content providers so that the providers know whether their content was displayed or not. In addition, logging the advertising and content information will ensure that advertising and content providers are not charged for content that was never displayed. For example, if it is expected that an ad for the Bay Area Rapid Transportation (BART) system is to be played for a flight going to Oakland Airport, but the flight gets canceled, then the advertiser would know that the ad didn't get displayed, so the advertiser wouldn't get charged anything. The group content information log file may also be useful for providing feedback to the advertiser regarding the effectiveness of the ad. For example, if an ad displayed a discount code for a concession stand at the airport, and the ad was displayed and every passenger used the discount code, then the advertising provider may conclude that the ad was very effective.

At 395, the group content information log file is transmitted to the server device 302. The group content information log file may be stored in the server device 302. The server device 302 may provide an interface for advertising and content providers to view the group content information log file to see the type of interest their ads and content had on the viewing public and also to see whether the ads or content actually were displayed.

Referring to FIG. 4, a flow diagram of a process 400 for creating a group playlist used for displaying the real-time digital content on a system is shown. A server device, such as server device 302 of FIG. 3, may create the group playlist and then transmit the group playlist to a client device, such as client device 308 of FIG. 3. The group playlist may identify the ad and content programming that should be displayed on the client device, which may be client device 308 of FIG. 3, and that was selected for a particular flight. The group playlist may also identify the order the ad and content programming should be played in.

At 410, a set of flight group scores is created for each flight. For example, a gender score is created indicating the ratio of men to women on a certain flight. Similarly, a business and leisure score may be created indicating the ratio of business travelers to leisure travelers on the flight. There may also be a resident score indicating the ratio of passengers living in a nearby county versus those who live farther away from the airport. There may be an age score indicating the number of adults or kids on a flight. These scores are created for each and every flight. For example, if the 8:00 am flight out of Santa Barbara on a Monday morning comprises mostly 80 males and 20 females, then the gender score might be 0.8 and 0.2 for men and women respectively. Similar such scores would be created for every flight on a given day. In addition to the identified list of gender scores, business and leisure score, resident score and an age score, other scores may also be created to aid in generating the playlist, such as a frequent flyer score, and the like.

At 415, the server device 302 receives the desired target group scores. The desired target group scores represent the desired targeted group information that the advertiser or content provider entered as the ad or content was uploaded to the server device. For example, a provider uploading an ad for the Bay Area Rapid Transportation (BART) system may indicate that it is desired that the passenger group include at least 60% business travelers. A score may then be assigned to the ad indicating 0.6 business travelers and 0.4 leisure travelers. Similarly, provider for the BART ad may state that it is desired that the passenger group further comprise 80% frequent flyers. A score may then be assigned to the ad indicating 0.8 frequent flyers and 0.2 non-frequent flyers. Additionally, the provider may state that it is desired that the passenger group include 55% men. A score may then be assigned to the ad indicating 0.55 men and 0.45 women. Similar such scores would be created for every ad and content stored in the server device. In addition to the identified list of gender scores, business and leisure score, and frequent flyer scores, other scores may also be created to define the ad and aid in generating the playlist, such as resident scores, age scores, and the like.

At 420, the flight factor weighing scores are incorporated into the data used to generate the playlist. The flight factor weighing scores are a list of scores that provide different weights for each of the characteristics being scored. That is, the flight factor weighing scores provide a score to aid in ranking the different characteristics for a certain flight. For example, an ad agency may provide information that for a Monday morning flight out of the Santa Barbara airport, the most important characteristic to target in the passenger group are men, versus other characteristics such as business versus leisure travelers, frequent flyer passengers, or local versus resident passengers. The flight factor weighing scores for the Monday morning flight may be as follows: 0.8 for gender, 0.1 for business/leisure travelers and 0.1 for frequent flyer travelers. As can be seen from the example, using the 0.8 gender flight factor weighing score implies that the gender characteristic will have a significant effect, as compared to the business/leisure traveler score and the frequent flyer score, on the overall ad ranking when the ads are ranked.

At 422, the category weighing scores are incorporated into the data used to generate the playlist. The category weighing scores are a list of scores that may provide different weights for each of the categories of advertisements and content. When an ad or content is originally uploaded to the server device, the ad may be tagged with the category that it belongs to. Examples of different categories include restaurants, hotels, retail, transportation, local attractions, professional services (law firms advertising), entertainment, tour providers, special events and other similar categories. For example, when an advertiser provides an ad regarding a hotel. The ad may be categorized as a “hotel” ad. The ad may further be categorized as a “boutique hotel”, and the like. Similarly, ads regarding retail shops may be categorized as “retail”. These “retail” ads may further be categorized as “high-end clothing retail”, or “jewelry retail”, and the like.

When creating the playlist, these categories may receive weighted scores to determine relevant ads and content for the passenger group. For example, if there is a special event occurring in Las Vegas, such as the Consumer Electronics Show (“CES”), the special event category may receive a higher weighted score than the other categories. This higher weighted score will ensure that advertisements or content regarding CES will be played for the passengers traveling to Las Vegas during CES, since they likely are traveling to Las Vegas to attend CES. Other categories may also receive higher weighted scores in this example to ensure that all relevant ad and content related to CES is shown. For example, the hotel category may be weighted higher than the professional services category, so that ads and content related to hotels that might be involved with hosting guests or displaying exhibits for CES will have a greater chance of being shown as opposed to professional services, since the passengers likely are traveling to Las Vegas to attend CES and would be interested in the CES related information. Alternatively, if there are no special events, or other external factors requiring different weights for certain categories, these categories may all receive the same weight.

At 425, the group characteristic scores are calculated. For example, the gender score is calculated by multiplying the gender score for the flight group score defined in 410, by the gender score for the desired target group score defined in 415 and further multiplied by the gender score for the flight factor weighing score defined in 420. Similarly, the business/leisure traveler score is calculated by multiplying the business/leisure traveler score for the flight group score defined in 410, by the business/leisure traveler score for the desired target group score defined in 415 and further multiplied by the business/leisure traveler score for the flight factor weighing score defined in 420. Similar such scores would be created for every characteristic based on the flight group score, the desired target group score and the flight factor weighing scores. In addition to the identified list of characteristics, other scores may also be created to define characteristics of the flight and desired targeted information and aid in generating the playlist, such as resident scores, age scores, and the like.

At 430, an overall content score is calculated. For example, after step 425, the BART ad may have a final gender score (based on multiplying the flight group gender score of 410 by the desired target group score for gender of 415 and by the flight factor weighing score for gender of 420), and it may have a final business/leisure traveler score (based on multiplying the flight group business/leisure travelers score of 410 by the desired target group score for business/leisure travelers of 415 and by the flight factor weighing score for business/leisure travelers of 420). These final scores, namely the final gender score and the final business/leisure traveler score may be added together. The overall content score may include scores for other characteristics such as age information, local versus resident information, and other similar characteristics.

At 435, the ads and content are ranked based on the overall content score. The ads and content are ranked in descending order, thereby ensuring that the most relevant ad for the group and the flight is played at the most optimum time.

At 440, the ranked list is checked to determine whether multiple ads or content received the same overall content score. If multiple ads or content received the same overall content score, then a new content order needs to be determined as seen in 450. The new content order may be determined by evaluating various factors. For example, the advertiser or content provider may have indicated what dates they want their ad to run, or how much they wish to spend monthly on their advertising. If two ads or content receive the same score, then the current date or the money each of the providers wish to spend on their marketing campaign may help determine which ad is ranked higher as compared to the other ad. Another way to break the tie between the two ads is to evaluate the frequency with which each ad was played. For example, if ad A was played more times than ad B in other group playlists, then maybe ad B could be played in this group playlist, and ad A skipped or scheduled to be played much later in this playlist. Other factors can also be used to determine which ad will be displayed prior to the other ad. Once a new content order is determined, then the process returns to step 440 to reevaluate whether any content has the same score as some other content. If no content has the same score as other content, then the process proceeds to step 445.

If multiple ads or content do not receive the same overall content score, then the process proceeds to step 445. At 445, the ranked list is checked to determine whether multiple ads of the same category are included in the playlist back-to-back. For example, it is not desired to play an ad for a hotel, followed by another ad for a hotel. Therefore, the ranked list is checked to determine whether multiple ads within the same category are played back-to-back. If multiple ads or content of the same category are in the order to be displayed back-to-back, then the process proceeds to 450 to determine the new content order. As explained above, numerous factors can help determine how to reorder the ranked list. For example, the advertiser or content provider may have indicated how much they wish to spend monthly on their advertising. If two ads or content receive the same score, then the money each of the providers wish to spend on their marketing campaign may help determine which ad is ranked higher as compared to the other ad. Another way to break the tie between the two ads is to evaluate the frequency with which each of the ads or content had been played. If ad A was played more frequently, then maybe ad B could be played earlier in the order of play in this group playlist, and ad A moved to a later order in this playlist. Other factors can also be used to determine which ad will be displayed prior to the other ad. If the ranked list does not comprise ad data having the category content repeated, then the process proceeds to step 455 where the final group playlist is generated.

Once the final group playlist is generated, the group playlist may be transmitted to the client device. Along with the group playlist, the ad and content information comprising the actual video content may also be transmitted to the client device. The client device then may display the ad and content that has been specifically created for a certain flight passenger group based on characteristics of the passenger group and the final destination information of the passenger group. Because the ad and content information have been specifically created based on numerous group specific parameters, there is a greater likelihood that the passengers waiting at a departure gate will be interested in the ad and content information as it has been specifically created for that group. Therefore, advertisers and content providers may be motivated to include their ad and content programming in the system described in this application because the ad and content displayed is specifically created for a captive audience who likely will view the ad and content information because it is relevant information that has been specifically created for them.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A system for delivering real-time digital content on a network comprising:
a server device comprising
a processor
a memory
wherein the processor and the memory comprise circuits and software for
receiving real-time flight information, an airport information and an airline information,
receiving content information, the content information including digital content and targeted group information,
generating a group playlist based on the real-time flight information, the airport information, the airline information, and the content information, and
transmitting the group playlist and a group content to a client device.

2. The system of claim 1, wherein the server device is configured to
query the real-time flight information to determine if new real-time flight information exists,
generate a second group playlist if new real-time flight information exists, wherein the second group playlist uses the new real-time flight information, and
transmit the second group playlist to the client device.

3. The system of claim 2, wherein the client device is configured to
receive the second group playlist and
display the second group playlist on the display unit of the client device.

4. The system of claim 1, wherein the server device is configured to
query the content information to determine if new content information exists,
generate a third group playlist if new content information exists, wherein the third group playlist uses the new content information, and
transmit the third group playlist to the client device.

5. The system of claim 4, wherein the client device is configured to
receive the third group playlist and
display the third group playlist on the display unit of the client device.

6. The system of claim 1, wherein the client device is configured to
create a group content information log file, wherein the group content information log file includes information about the content that was displayed on the display unit of the client device, and
transmit the group content information log file to the server device.

7. The system of claim 6, wherein the group content information log file includes a day of the week information and a time of the day information indicating when the content was displayed on the display unit.

8. The system of claim 7, wherein the group content information log file includes a group passenger information including the gender ratio of the group passenger information on the flight.

9. The system of claim 1, wherein the client device is located at a gate in a terminal at an airport.

10. A method for delivering real-time digital content on a network comprising:
a server device receiving real-time flight information, an airport information and an airline information
a server device receiving content information, the content information including a set of digital content and targeted group information
a server device generating a group playlist based on the real-time flight information, the airport information, the airline information, and the content information
a server device transmitting the group playlist and a group content to a client device.

11. The method of claim 10, wherein the group playlist is generated by
creating a set of flight group scores, wherein the set of flight group scores indicate the characteristics of a passenger group for a flight
creating a set of desired targeted group scores for each content in the set of digital content, wherein the set of desired targeted group scores indicate the characteristics of a desired passenger group for a flight
calculating an overall score for each content in the set of digital content using the set of flight group scores and the set of desired targeted group scores and
ranking each content in the set of digital content based on its overall score.

12. The method of claim 11, further comprising
the server device querying the real-time flight information to determine if new real-time flight information exists
the server device generating a second group playlist if new real-time flight information exists, wherein the second group playlist uses the new real-time flight information
and the server device transmitting the second group playlist to the client device.

13. The method of claim 12, wherein the new real-time flight information includes new terminal and gate information for the flight.

14. The method of claim 10, further comprising
the server device querying the content information to determine if new content information exists,
generating a third group playlist if new content information exists, wherein the third group playlist uses the new content information, and
transmitting the third group playlist to the client device.

15. The method of claim 10, further comprising
the client device receiving the third group playlist and
the client device displaying the third group playlist on the display unit of the client device.

16. The method of claim 10, further comprising
the client device creating a group content information log file, wherein the group content information log file includes information about the content that was displayed on the display unit of the client device, and
the client device transmitting the group content information log file to the server device.

17. The method of claim 16, wherein the group content information log file includes a day of the week information and a time of the day information indicating when the content was displayed on the display unit.

18. The method of claim 17, wherein the group content information log file includes a group passenger information including the gender ratio of the group passenger information on the flight.

19. The method of claim 10, wherein the real-time flight information further includes a flight destination and terminal and gate information, wherein the terminal and gate information indicates the terminal and gate departure information for a flight.

20. The method of claim 10, wherein the client device is located at a gate in a terminal at an airport.
